(19) United States
(12) Patent Application Publication
(10) Pub. No.: US 2020/0053242 A1
(43) Pub. Date: Feb. 13, 2020

(54) BOOK ELECTRONIZATION APPARATUS AND BOOK ELECTRONIZATION METHOD

(71) Applicant: SHARP KABUSHIKI KAISHA, Sakai City (JP)

(72) Inventors: TOHRU NAKANISHI, Sakai City (JP); ZENKEN KIN, Osaka (JP)

(21) Appl. No.: 16/527,778

(22) Filed: Jul. 31, 2019

(30) Foreign Application Priority Data
Aug. 8, 2018 (JP) 2018-149765

(51) Int. Cl. H04N 1/00; G06T 7/49; G06T 3/00; G06T 11/00

(52) U.S. Cl. CPC H04N 1/00827; G06T 7/49; H04N 2201/0434; G06T 11/003; G06T 3/0037

(57) ABSTRACT

A book electronization apparatus includes: a three-dimensional data generation unit that generates three-dimensional data; a two-dimensional page data generation unit that generates two-dimensional page data which has first points as points corresponding to ink and second points as values corresponding to a background; and a character recognition unit that recognizes a character by using the two-dimensional page data. The character recognition unit recognizes the character on the basis of a shape of a part of the character, which is generated by connecting the first points with one of the first points as an initial point in a partial region of a character region.

### BACKGROUND

### 1. Field

The present disclosure relates to a book electronization apparatus or the like that electronizes a character described in a book.

### 2. Description of the Related Art

When a book is opened for reading, the book is damaged in some cases. In particular, an old book may be damaged or destroyed when being opened. For example, an ancient rolled document that was burnt by the eruption in ancient Roman times was discovered in Italy. The ancient document is difficult to be interpreted with unaided eyes because it is entirely blackish, and is difficult to be unrolled because it is fragile. Thus, by performing X-ray phase-contrast tomography for such a book, three-dimensional data of the book is acquired without damaging the book.

A book electronization apparatus that generates two-dimensional page data corresponding to each page of a book from three-dimensional data as described above is known. A book electronization apparatus described in International Publication No. WO2017/131184 specifies a page region corresponding to a page of a book by using three-dimensional data of the book, maps a character in the page region to a two-dimensional plane, and thereby generates two-dimensional page data including the character described in the book. Note that, the character here means a plurality of points before recognition and the character is recognized from the plurality of points.

As a step subsequent to a two-dimensional page data generation step by the book electronization apparatus described above, there is a step of recognizing the character described in the book. At the step, the character is recognized by using, as an initial point, one of a plurality of points (nodes) which are included in the two-dimensional page data and which have a value corresponding to ink and connecting the plurality of points having the value corresponding to the ink. In this case, all the points are connected for one character, thus posing a problem that it takes a time to recognize the character.

An aspect of the disclosure is made in view of the aforementioned problem and achieves a book electronization apparatus and a book electronization method that are able to efficiently recognize a character from two-dimensional page data.

### SUMMARY

To cope with the aforementioned problem, a book electronization apparatus according to an aspect of the disclosure includes: a three-dimensional data generation unit that captures an image of a book and generates three-dimensional data of the book; a two-dimensional page data generation unit that generates two-dimensional page data which corresponds to a page of the book in the three-dimensional data and which has first points as points corresponding to ink and second points as values corresponding to a background; and a character recognition unit that recognizes a character described in the page by using the two-dimensional page data, in which the character recognition unit recognizes the character on a basis of a shape of a part of the character, which is generated by connecting the first points with one of the first; points as an initial point in a partial region of a character region serving as a region of the two-dimensional page data corresponding to a region where one character is described in the page.

To cope with the aforementioned problem, a book electronization method according to an aspect of the disclosure includes: capturing an image of a book and generating three-dimensional data of the book; generating two-dimensional page data which corresponds to a page of the book in the three-dimensional data and which has first points as points corresponding to ink and second points as values corresponding to a background; and recognizing a character described in the page by using the two-dimensional page data, wherein in the recognizing, the character is recognized on a basis of a shape of a part of the character, which is generated by connecting the first points with one of the first points as an initial point in a partial region of a character region serving as a region of the two-dimensional page data corresponding to a region where one character is described in the page.

### BRIEF DESCRIPTION OF THE DRAWINGS

FIG 1 is a block diagram illustrating a configuration of a principal part of a book electronization apparatus according to Embodiment 1 of the disclosure;

FIG. 2 is a flowchart illustrating an example of a flow of processing of the book electronization apparatus;

FIGS. 3A and 3B are views for explaining proliferation of a node by a node proliferation unit included in the book electronization apparatus, in which FIG. 3A illustrates a character string to be recognized by the book electronization apparatus and FIG. 3B illustrates proliferation of a node by the node proliferation unit;

FIG. 4 is a view for explaining an example of a method of deciding a character by a character decision unit included in the book electronization apparatus; and

FIG. 5 is a block diagram illustrating a configuration of a principal part of a book electronization apparatus according to Embodiment 2 of the disclosure.

### DESCRIPTION OF THE EMBODIMENTS

### Embodiment 1

An embodiment of the disclosure will be described in detail below.

### Configuration of Book Electronization Apparatus 1A

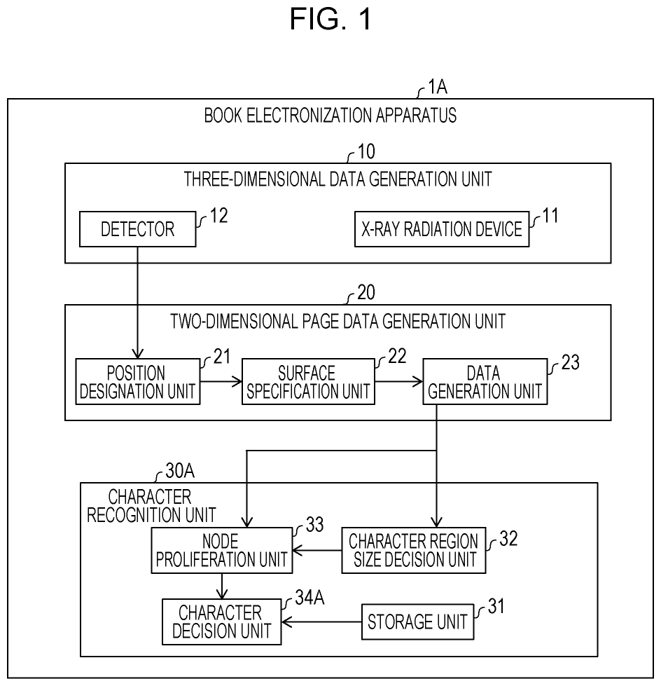

FIG. 1 is a block diagram illustrating a configuration of a principal part of a book electronization apparatus 1A in the present embodiment. As illustrated in FIG. 1, the book electronization apparatus 1A includes a three-dimensional data generation unit 10, a two-dimensional page data generation unit 20, and a character recognition unit 30A.

The three-dimensional data generation unit 10 captures an image of a book and generates three-dimensional data of the book. The three-dimensional data generation unit 10 includes an X-ray radiation device 11 and a detector 12 as illustrated in FIG. 1.

The X-ray radiation device 11 radiates an X-ray to the book. The X-ray radiation device 11 is configured to enable adjustment of an output (wavelength) of radiation of the X-ray, for example, and is able to radiate the X-ray with a desired wavelength to the book.

The detector 12 detects the X-ray radiated to the book. The detector 12 is configured to acquire detection values which include detection positions of the X-ray and intensity of the X-ray at the positions. The detector 12 outputs the acquired detection values as three-dimensional data to the two-dimensional page data generation unit 20 (more specifically, a position designation unit 21).

The two-dimensional page data generation unit 20 generates, from the three-dimensional data generated by the three-dimensional data generation unit 10, two-dimensional page data which includes information about a plurality of points (hereinafter, referred to as first points in some cases) each having a value corresponding to ink and a plurality of points (second points) each having a value corresponding to a background. The two-dimensional page data corresponds to a page of the book. The two-dimensional page data generation unit 20 includes the position designation unit 21, a surface specification unit 22, and a data generation unit 23 as illustrated in FIG. 1.

On the basis of data values of the three-dimensional data output from the detector 12, the position designation unit 21 designates an initial point for specifying a page region. The page region is a part corresponding to each of pages of the book in the three-dimensional data and is a set of nodes existing on a certain surface corresponding to each of the pages. The position designation unit 21 outputs information about the initial point to the surface specification unit 22.

The surface specification unit 22 specifies a page region connected to the initial point designated by the position designation unit 21. The surface specification unit 22 outputs a set of points corresponding to the page region and data values of the respective points to the data generation unit 23.

The data generation unit 23 converts the data of the page region specified by the surface specification unit 22 into two-dimensional (planar) page data (hereinafter, referred to as two-dimensional page data). The two-dimensional page data includes information about a plurality of points each having the value corresponding to the ink or the value corresponding to the background, and includes information about a positional relation of a plurality of characters or graphics (arrangement of the characters or the like) in a page of the book. The data generation unit 23 outputs the generated two-dimensional page data to the character recognition unit 30A (more specifically, a character region size decision unit 32 and a node proliferation unit 33).

The character recognition unit 30A specifies (recognizes) a character from a plurality of points which are included in the two-dimensional page data generated by the two-dimensional page data generation unit 20 and each of which has the value corresponding to the ink. The character recognition unit 30A includes a storage unit 31, the character region size decision unit 32, the node proliferation unit 33, and a character decision unit 34A.

The storage unit 31 stores a unique point of a character. In other words, the storage unit 31 stores a unique point of a character (for example, a hiragana character, a katakana character, a Chinese character, an alphabet, a numeral, or the like). The “unique point” in the present specification is a point that is indispensable to constitute the character. The number of unique points of one character is not particularly limited and may be different depending on a character.

The character region size decision unit 32 decides a size of a region of one character from the two-dimensional page data generated by the data generation unit 23. Details thereof will be described later.

The node proliferation unit 33 uses one of a plurality of points (first points) each having the value corresponding to the ink as an initial point in the region of one character, which is decided by the character region size decision unit 32, and connects (in the present specification, referred to as “proliferates” in some cases) the first points to thereby generate a shape of a part of the character. The node proliferation unit 33 proliferates a node in a partial region (for example, 50% of the region) in the region of one character, which is decided by the character region size decision unit 32.

On the basis of the shape of the part of the character generated by the node proliferation unit 33, the character decision unit 34A decides the character described in the region of one character, which is decided by the character region size decision unit 32. Details thereof will be described later.

### Example of Processing of Book Electronization Apparatus 1A

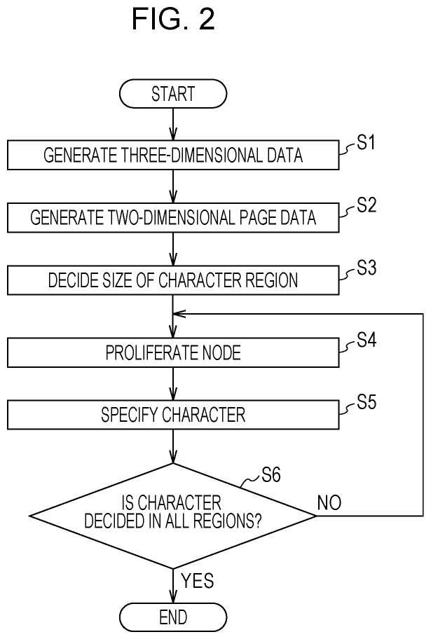

FIG. 2 is a flowchart illustrating an example of a flow of processing (book electronization method) of the book electronization apparatus 1A. As illustrated in FIG. 2, in the processing in the book electronization apparatus 1A, first, the three-dimensional data generation unit 10 captures an image of a book and generates three-dimensional data of the book (S1, three-dimensional data generation step). Specifically, the X-ray radiation device 11 radiates an X-ray to the book and the detector 12 detects the X-ray. The X-ray radiation device 11 radiates the X-ray to the book in a closed state. A part of the X-ray radiated from the X-ray radiation device 11 is absorbed by the ink in the book.

The detector 12 detects detection values which include specific positions and intensity of the X-ray that has passed through the book, and outputs the detected detection values as three-dimensional data to the two-dimensional page data generation unit 20 (more specifically, the position designation unit 21). The X-ray that has passed through a region where the ink exists in the book is detected by the detector 12 as an X-ray having intensity lower than that of an X-ray that has passed through a medium (paper) of the book. A set of the detection values forms three-dimensional data which includes a point where such an X-ray having low intensity is detected. The three-dimensional data is data that includes information about a position of the ink or a paper surface (background) and information about intensity of the X-ray at the position. In this manner, by capturing the image of the book with use of the X-ray, the three-dimensional data of the ink in the book is acquired.

Next, the two-dimensional page data generation unit 20 generates, from the three-dimensional data generated by the three-dimensional data generation unit 10, two-dimensional page data that includes information about a plurality of points (nodes) each having the value corresponding to the ink or the value corresponding to the background (S2, two-dimensional page data generation step). Specifically, first, the position designation unit 21 designates a linear path so that the linear path crosses at least one medium (one page in a case where the book is a booklet) among media that are overlapped in the three-dimensional data. For example, in the case where the book is a booklet, the path is a straight line that passes through a front cover and a back cover of the book and crosses all pages of the book.

Then, the position designation unit 21 designates a point, which corresponds to a threshold for distinguishing a data value of a sheet and a data value of a gap, in the path as an initial point of a page region. For example, the position designation unit 21 designates a plurality of initial points corresponding to a plurality of page regions. The position designation unit 21 outputs information about the initial point to the surface specification unit 22.

Next, the surface specification unit 22 specifies a position of a page region decided on the basis of the initial point. For example, the page region is disposed, in orthogonal coordinates of the three-dimensional data, so as to cross a unit cell constituting the orthogonal coordinates The surface specification unit 22 specifies the page region by setting points, which have values equal to or more than the threshold in sides of the unit cell in which the page region traverses, as points corresponding to the page region, for example.

Next, the data generation unit 23 generates the two-dimensional page data by mapping data values of the respective points of the page region specified by the surface specification unit 22 onto a two-dimensional plane. The data values of the respective points of the two-dimensional page data substantially correspond to either the sheet (background) or the ink. A known method (for example, such as three-dimensional mesh deployment utilizing saddle point characteristics) is able to be used as a method of mapping.

Next, the character recognition unit 30A recognizes a character included in the two-dimensional page data generated by the data generation unit 23 (character recognition step).

Specifically, first, the character region size decision unit 32 decides a region (or a region size) of one character on the basis of the two-dimensional page data generated by the data generation unit 23 (S3). For example, in a case where a size of a character which has been described in the book and a distance between characters adjacent to each other are known, the character region size decision unit 32 decides the region of one character on the basis of the size of the character and the distance between the characters adjacent to each other. On the other hand, in a case where a size of a character described in the book and a distance between characters adjacent to each other are known, for example, the node proliferation unit 33 connects all first points with any point of the first points as an initial point in any one line of a character string described in the book and thereby generates one character. Such processing is executed for characters described in the any one line. Thereby, the character region size decision unit 32 is able to acquire the size of the character described in the book and the distance between the characters adjacent to each other, and is thus able to decide the region of one character.

Next, in the region of one character (hereinafter, also referred to as a character region), which is decided by the character region size decision unit 32, the node proliferation unit 33 connects first points in a partial region of the character region with one of the first points as an initial point (54).

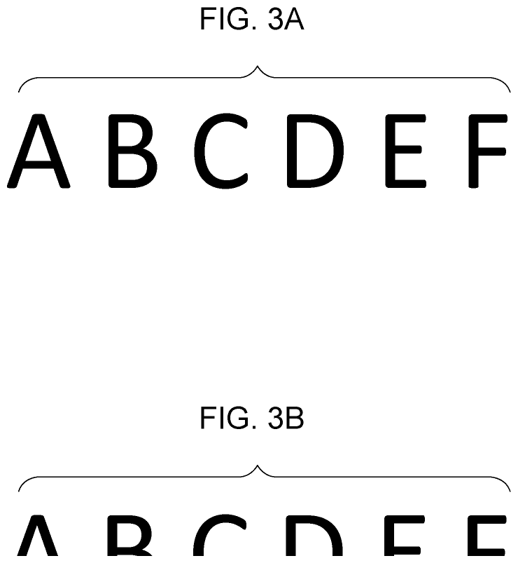

FIGS. 3A and 3B are views for explaining proliferation of a node by the node proliferation unit 33. FIG. 3A illustrates a character string to be recognized by the book electronization apparatus 1A and FIG. 3B illustrates proliferation of a node by the node proliferation unit 33.

Here, a case where the book electronization apparatus 1A recognizes a character in one line where “A” to “F” are described as illustrated in FIG. 3A will be described.

First, the node proliferation unit 33 uses any first point, which exists in a center of the character region, as an initial point. Next, the node proliferation unit 33 connects first points in an upper-half region from the center of the character region. Thereby, as illustrated in FIG. 3B, a shape of a character is generated in the upper-half region from the center of the character region. That is, the node proliferation unit 33 connects the first points with one of the first points as the initial point in a partial region (predetermined region) of the character region and thereby generates the shape of the part of the character.

Next, on the basis of the shape of the part of the character generated by the node proliferation unit 33, the character decision unit 34A decides a character described in a region of one character, which is decided by the character region size decision unit 32 (S5). Note that, information about shapes of characters is stored in the storage unit 31. The character decision unit 34A refers to the information about shapes of characters stored in the storage unit 31 and specifies a character on the basis of the shape of the part of the character generated by the node proliferation unit 33.

For example, as for a character “A”, the character decision unit 34A is able to specify the character as “A” on the basis of a shape of the character in the upper-half part from the center of the character region as illustrated in FIG. 3B.

On the other hand, the other characters are not able to be specified on the basis of a shape of each of the characters in the upper-half part from the center of the character region. For example, a character “B” may be the character “B” or a character “P”. Further, it is not possible to specify whether a character “E” or a character “F” is any of the character “E” and the character “F”. That is, there are a plurality of candidate characters of the character “E” and the character “F”.

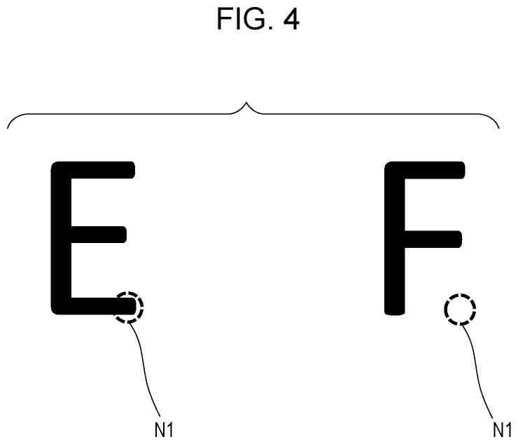

In this case, when a unique point of a candidate character exists in a region other than a region where a node is proliferated in the character region, the character decision unit 34A recognizes a character as the candidate character. This will be specifically described by taking the character “E” and the character “F” as an example with reference to FIG. 4.

FIG. 4 is a view for explaining an example of a method of deciding a character by the character decision unit 34A. As illustrated in FIG. 4, the character decision unit 34A determines whether a node N1 which is a unique point of the character “E” is a point (first point) having the value corresponding to the ink. When the node N1 is the first point, the character decision unit 34A specifies the character as “E”. On the other hand, when the node N1 is not the first point (that is, when being a point (second point) having the value corresponding to the background), the character decision unit 34A specifies the character as “F”.

Next, the character recognition unit 30A determines whether the two-dimensional page data has a region in which a character is not decided yet (S6). When there is a region in which a character is not decided yet (NO at S6), the character recognition unit 30A performs step S4 and step S5 for a next region. On the other hand, when a character is decided in all the regions, the book electronization apparatus 1A ends the processing.

As described above, in the book electronization apparatus 1A, the character recognition unit 30A recognizes (specifies) a character on the basis of a shape of a part of the character obtained by connecting first points with one of the first points as an initial point in a partial region (that is, upper-half part) of a character region which is a region of two-dimensional page data corresponding to a region where one character is described in a page of a book in three-dimensional data.

Conventionally, first points are connected in an entire region of a character region, so that there is a problem that a processing time is long. On the other hand, according to the aforementioned configuration, first points are connected with one of the first points as an initial point in a partial region (that is, upper-half part) of a character region and a shape of a part of a character is thereby generated. Then, the character decision unit 34A recognizes the character on the basis of the generated shape of the character. Thus, processing of connecting first points is able to be reduced, thus making it possible to reduce a processing time to specify a character. That is, the book electronization apparatus 1A is able to efficiently recognize the character from two-dimensional page data.

Note that, though the present embodiment has a configuration in which first points are connected with one of the first points as an initial point in an upper-half region of a character region, the book electronization apparatus of the disclosure is not limited thereto. A book electronization apparatus of an aspect of the disclosure may have a configuration in which first points are connected with one of the first points as an initial point, for example, in upper one-third of a character region. Moreover, a book electronization apparatus of an aspect of the disclosure may have a configuration in which first points are connected with one of the first points as an initial point, for example, in upper two-thirds of a character region. Further, a region where first points are connected is not limited to an upper partial region of the character region, and may be, for example, a lower partial region of the character region, a left-side partial region of the character region, or a right-side partial region of the character region. Further, a region where first points are connected may be an upper partial region and a lower partial region of the character region.

Note that, there is a case where a region which is easily specified exists depending on a type (for example, a numeral, an alphabet, a hiragana character, a katakana character, or a Hangul character) of a character. Thus, it is desirable that a region where first points are connected is appropriately set in accordance with a type of a character.

Moreover, it is desirable that a direction in which first points are connected is differentiated in accordance with a type of a character. This makes it possible to reduce a region where the first points are connected, thus making it possible to further reduce processing of connecting the first points.

### Embodiment 2

Another embodiment of the disclosure will be described below. Note that, for convenience of description, members having the same functions as those of the members described in the aforementioned embodiment will be given the same reference signs and description thereof will not be repeated.

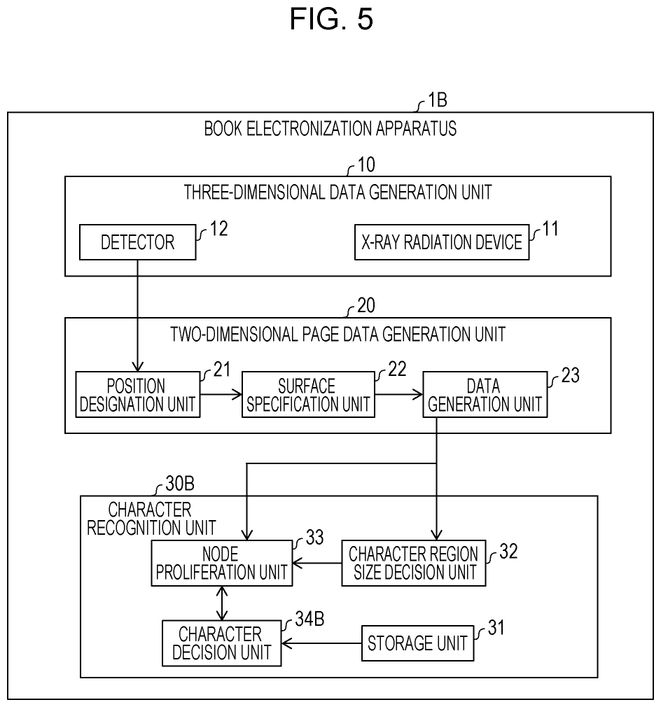

FIG. 5 is a block diagram illustrating a configuration of a principal part of a book electronization apparatus 1B in the present embodiment. As illustrated in FIG. 5, the book electronization apparatus 1B includes a character recognition unit 30B instead of the character recognition unit 30A in Embodiment 1. The character recognition unit 30B includes a character decision unit 34B instead of the character decision unit 34A in Embodiment 1.

The character decision unit 34B is the same as the character decision unit 34A in Embodiment 1 in terms of deciding, on the basis of a shape of a part of a character generated by the node proliferation unit 33, the character described in a region of one character decided by the character region size decision unit 32, but is different therefrom in a method of processing thereof. That is, the book electronization apparatus 1B is different from that of Embodiment 1 in the processing of step S5 in FIG. 2.

In the processing of step S5 in the book electronization apparatus 1B, whether a character is able to be specified by connecting first, points with one of the first points as an initial point in an upper-half region of a character region is determined. This processing is as described in Embodiment 1.

In the processing of step S5 in the book electronization apparatus 1B, when the character is not able to be specified, the node proliferation unit 33 further connects first points in a region other than the upper-half part in the character region. Thereby, a shape of the character is further generated. Then, the character decision unit 34B specifies the character on the basis of the further generated shape of the character. Note that, a range in which the first points are further connected is not an entire region of a lower-half part of the character region but a partial region of the lower-half part of the character region. Note that, the partial region of the lower-half part is able to be appropriately set in a range in which the character is able to be specified.

According to the aforementioned configuration, a shape of a part of a character is generated by connecting first points with one of the first points as an initial point in a partial region (that is, an upper-half region or a partial region of a lower-half part) of a character region. Then, the character decision unit 34B recognizes a character on the basis of the generated shape of the character. Thus, it is possible to reduce processing of connecting the first points compared to a conventional case, thus making it possible to reduce a processing time to specify the character. That is, the book electronization apparatus 1B is able to efficiently recognize the character from two-dimensional page data.

### Implementation Example by Software

A control block (particularly, the three-dimensional data generation unit 10, the two-dimensional page data generation unit 20, or the character recognition unit 30A or 30B) of the book electronization apparatus 1A or 1B may be implemented by a logic circuit (hardware) formed in an integrated circuit (IC chip) or the like or may be implemented by software.

In the latter case, the book electronization apparatus 1A or 1B includes a computer that executes a command of a program that is software implementing each of the functions. For example, the computer includes at least one processor (control apparatus) and includes at least one computer readable recording medium having the program stored therein. The disclosure is achieved when the processor reads and executes the program from the recording medium in the computer. As the processor, for example, a CPU (Central Processing Unit) is able to be used. As the recording medium, a tape, a disk, a card, a semiconductor memory, or a programmable logic circuit is able to be used in addition to a “non-transitory tangible medium” such as a ROM (Read Only Memory). Further, a RAM (Random Access Memory) that develops the program, or the like may be further included. Moreover, the program may be supplied to the computer via any transmission medium (such as a communication network or a broadcast wave) which allows the program to be transmitted. Note that, an aspect of the disclosure can also be implemented in a form of a data signal in which the program is embodied through electronic transmission and which is embedded in a carrier wave.

### CONCLUSION

A book electronization apparatus 1A or 1B according to an aspect 1 of the disclosure includes: a three-dimensional data generation unit 10 that captures an image of a book and generates three-dimensional data of the book; a two-dimensional page data generation unit 20 that generates two-dimensional page data which corresponds to a page of the book in the three-dimensional data and which has first points as points corresponding to ink and second points as values corresponding to a background; and a character recognition unit 30A or 30B that recognizes a character described in the page by using the two-dimensional page data, in which the character recognition unit recognizes the character on a basis of a shape of a part of the character, which is generated by connecting the first points with one of the first points as an initial point in a partial region of a character region serving as a region of the two-dimensional page data corresponding to a region where one character is described in the page.

The book electronization apparatus according to an aspect 2 of the disclosure may have a configuration in which the character recognition unit generates the shape of the part of the character by connecting the first points with one of the first points as the initial point in a predetermined region as the partial region, and in a case where a plurality of candidate characters of the character are obtained on a basis of the generated shape of the part of the character, when a unique point of a candidate character exists in a region other than the predetermined region of the character region, recognizes the character as the candidate character, in the aspect 1.

The book electronization apparatus according to an aspect 3 of the disclosure may have a configuration in which the character recognition unit generates the shape of the part of the character by connecting the first points with one of the first points as the initial point in a predetermined region as the partial region, and in a case where the character is not able to be specified on a basis of the generated shape of the part of the character, further connects the first points in a region other than the predetermined region of the character region, in the aspect 1.

The book electronization apparatus according to an aspect 4 of the disclosure may further include a character region size decision unit 32 that, decides a size of the character region, in the aspect 1.

The book electronization apparatus according to an aspect 5 of the disclosure may have configuration in which a direction in which the first points are connected is differentiated in accordance with a type of the character, in the aspect 1.

A book electronization method according to an aspect 6 of the disclosure includes: capturing an image of a book and generating three-dimensional data of the book; generating two-dimensional page data which corresponds to a page of the book in the three-dimensional data and which has first points as points corresponding to ink and second points as values corresponding to a background; and recognizing a character described in the page by using the two-dimensional page data, wherein in the recognizing, the character is recognized on a basis of a shape of a part of the character, which is generated by connecting the first points with one of the first points as an initial point in a partial region of a character region serving as a region of the two-dimensional page data corresponding to a region where one character is described in the page.

The book electronization apparatus according to each of the aspects of the disclosure may be implemented by a computer. In this case, a control program of the book electronization apparatus, which causes the computer to operate as each unit (software element) included in the book electronization apparatus to thereby implement the book electronization apparatus in the computer, and a computer readable recording medium storing the control program are also included in a scope of the disclosure.

The disclosure is not limited to each of the embodiments described above, and may be modified in various manners within the scope indicated in the claims and an embodiment, achieved by appropriately combining techniques disclosed in each of different embodiments is also encompassed in the technical scope of the disclosure. Further, by combining the techniques disclosed in each of the embodiments, a new technical feature may be formed.

The present disclosure contains subject matter related to that disclosed in Japanese Priority Patent Application JP 2018-149765 filed in the Japan Patent Office on Aug. 8, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A book electronization apparatus comprising:
a three-dimensional data generation unit that captures an image of a book and generates three-dimensional data of the book;
a two-dimensional page data generation unit that generates two-dimensional page data which corresponds to a page of the book in the three-dimensional data and which has first points as points corresponding to ink and second points as values corresponding to a background; and
a character recognition unit that recognizes a character described in the page by using the two-dimensional page data, wherein
the character recognition unit recognizes the character on a basis of a shape of a part of the character, which is generated by connecting the first points with one of the first points as an initial point in a partial region of a character region serving as a region of the two-dimensional page data corresponding to a region where one character is described in the page.

2. The book electronization apparatus according to claim 1, wherein
the character recognition unit
generates the shape of the part of the character by connecting the first points with one of the first points as the initial point in a predetermined region as the partial region, and
in a case where a plurality of candidate characters of the character are obtained on a basis of the generated shape of the part of the character, when a unique point of a candidate character exists in a region other than the predetermined region of the character region, recognizes the character as the candidate character.

3. The book electronization apparatus according to claim 1, wherein
the character recognition unit
generates the shape of the part of the character by connecting the first points with one of the first points as the initial point in a predetermined region as the partial region, and
in a case where the character is not able to be specified on a basis of the generated shape of the part of the character, further connects the first points in a region other than the predetermined region of the character region.

4. The book electronization apparatus according to claim 1 further comprising a character region size decision unit that decides a size of the character region.

5. The book electronization apparatus according to claim 1, wherein a direction in which the first points are connected is differentiated in accordance with a type of the character.

6. A book electronization method comprising:
capturing an image of a book and generating three-dimensional data of the book;
generating two-dimensional page data which corresponds to a page of the book in the three-dimensional data and which has first points as points corresponding to ink and second points as values corresponding to a background; and
recognizing a character described in the page by using the two-dimensional page data, wherein
in the recognizing, the character is recognized on a basis of a shape of a part of the character, which is generated by connecting the first points with one of the first points as an initial point in a partial region of a character region serving as a region of the two-dimensional page data corresponding to a region where one character is described in the page.
